(19) United States
(12) Patent Application Publication
(10) Pub. No.: US 2007/0088673 A1
(43) Pub. Date: Apr. 19, 2007

(54) SYSTEM AND PROCESSES FOR COMMERCIALIZING INTELLECTUAL PROPERTY

(75) Inventor: Curtis A. Vock, Boulder, CO (US)

Correspondence Address: LATHROP & GAGE LC, 4845 PEARL EAST CIRCLE, SUITE 300, BOULDER, CO, 80301, US

(73) Assignee: ThinkVillage, LLC

(21) Appl. No.: 11/559,335

(22) Filed: Nov. 13, 2006

Related U.S. Application Data
(63) Continuation-in-part of application No. 10/304,334, filed on Nov. 26, 2002.
(60) Provisional application No. 60/333,557, filed on Nov. 26, 2001.
(60) Provisional application No. 60/736,022, filed on Nov. 10, 2005.
(60) Provisional application No. 60/763,146, filed on Jan. 27, 2006.

(51) Int. Cl. G06F 17/30

(52) U.S. Cl. 707/1

(57) ABSTRACT

Systems and a software product commercialize intellectual property. An idea submission is received. The idea submission is communicated to an appropriate person of a filter network. The idea submission is submitted to an appropriate attorney/agent of a patent attorney network if the idea submission is accepted by the filter network. Intellectual property representative of the idea submission is posted as Pending IP.

### RELATED APPLICATIONS

This application claims priority as a continuation-in-part to U.S. Non-Provisional application Ser. No. 10/304,334, which claims priority to Provisional Application No. 60/333,557, both of which are hereby incorporated by reference. This application also claims priority to Provisional Application No. 60/736,022 filed Nov. 10, 2005 and Provisional Application No. 60/763,146 filed Jan. 27, 2006, both of which are hereby incorporated by reference.

### BACKGROUND

The patent systems around the world are quite complex and costly. An average U.S. patent costs $15,000-$30,000 from start to issuance, and typically encompasses a process of one to five years. In that time, the “idea” for the patent may become stale; the original inventor may also never benefit from the patent, even if he can afford it; and, because the patent system is shrouded in secrecy, the world generally cannot take immediate advantage of new innovation. Moreover, once a patent issues, the “idea” for the patent may have been conceived of, and/or developed by, another company; the “cost” associated with settling a dispute has risen over the intervening time to obtain the patent. The cost of litigation is rising every day.

### SUMMARY

In one embodiment, a software product has instructions, stored on computer-readable media, wherein the instructions, when executed by a computer, perform steps for commercializing intellectual property, including instructions for receiving an idea submission, instructions for communicating the idea submission to an appropriate person of a filter network, instructions for submitting the idea submission to an appropriate attorney/agent of a patent attorney network if the idea submission is accepted by the filter network, and instructions for posting intellectual property representative of the idea submission as Pending IP. In another embodiment, a system commercializes intellectual property. The system has an IP server, a filter network for filtering ideas to the IP

server, and a patent attorney network for filing patents on ideas accepted by the filter network. The IP server posts filed patents, or portions thereof, as Pending IP, and is capable of transacting Pending IP through electronic communication.

In another embodiment, a system commercializes intellectual property, and includes means for processing one or more ideas submitted to the system, means for acquiring title to the ideas; means for facilitating patenting of the ideas, means for posting pending IP representative of the ideas, means for transacting sale or license of the pending IP, means for automatically attributing and allocating revenues to persons associated with processing, patenting and protecting the pending IP, means for processing submitted prior art in association with pending IP, and means for searching prior art databases to associate prior art with pending IP.

### BRIEF DESCRIPTION OF THE FIGURES

FIG. 1 shows an embodiment of one system for commercializing intellectual property.

FIG. 2 shows a flowchart illustrating an idea submission process for commercializing intellectual property, in accord with an embodiment.

FIG. 3 shows a flowchart illustrating an idea acquisition and patent prosecution process for commercializing intellectual property, in accord with an embodiment.

FIG. 4 shows a flowchart illustrating an idea acquisition process for commercializing intellectual property, in accord with an embodiment.

FIG. 5 shows a flowchart illustrating a post Pending IP process for commercializing intellectual property, in accord with an embodiment.

FIG. 6 shows a flowchart illustrating a sell Pending IP process for commercializing intellectual property, in accord with an embodiment.

FIG. 7 shows a flowchart illustrating a prior art association process for commercializing intellectual property, in accord with an embodiment.

FIG. 8 shows a notify potential buyer process for commercializing intellectual property, in accord with an embodiment.

FIG. 9 shows a distribute earnings process for commercializing intellectual property, in accord with an embodiment.

FIG. 10 shows a block schematic view of another system for commercializing intellectual property.

FIG. 11 shows a flowchart illustrating one exemplary process of the system of FIG. 10.

### DETAILED DESCRIPTION OF THE FIGURES

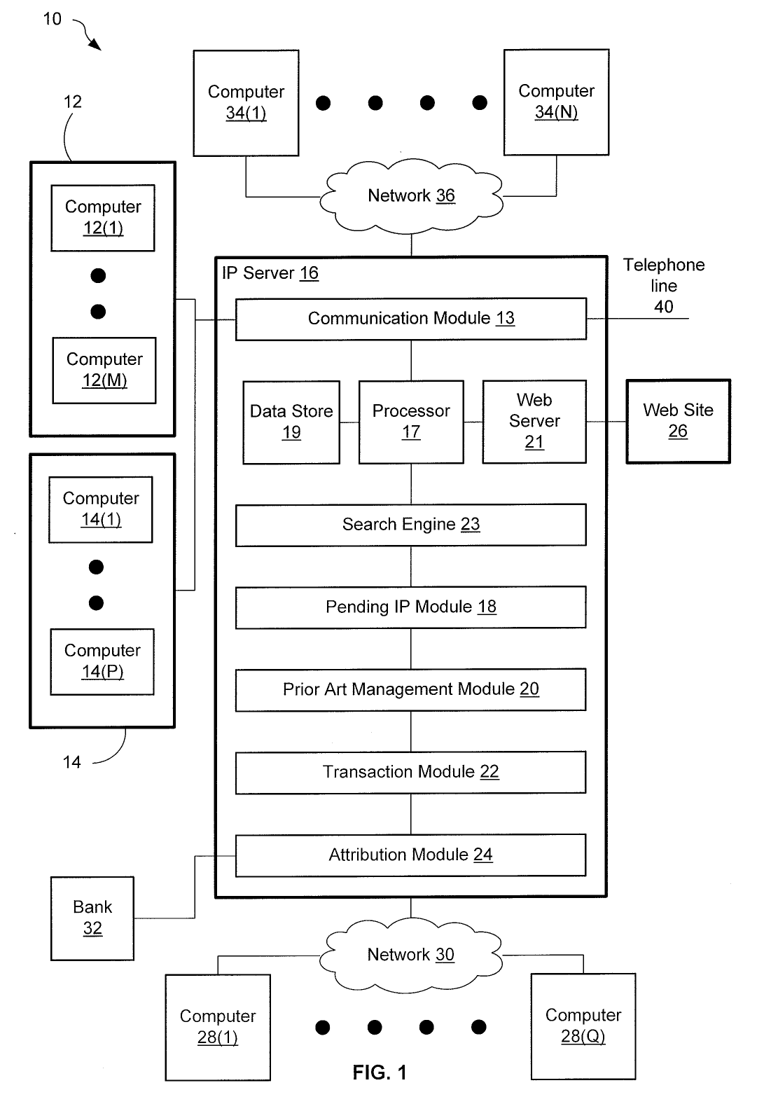

FIG. 1 shows system 10 for commercializing intellectual property. System 10 includes a filter network 12, a patent attorney network 14, and an intellectual property (IP) server 16. The filter network 12 is, for example, a group of computers (illustratively shown as computers 12(1) . . . 12(M), M being an integer) operated by a science and business (S&B) board and functioning to “filter” ideas submitted to system 10, such as more fully discussed herein below. Members of the S&B board may be diversely located, including being located in different countries. IP server 16 may include a communication module 13 which parses email or text (e.g., in a Word document describing the idea) of an idea submitted to system 10 via a computer 34; communication module 13 in particular may operate to parse words of the current submission so that it is routed to the appropriate computer 12(1) . . . 12(M). The patent attorney network 14 is, for example, a group of computers (illustratively shown as computers 14(1) . . . 14(P), P being an integer) operated by patent attorneys/agents and functioning to patent the ideas accepted by filter network 12. These patent attorneys may be diversely located, including being located in different countries. Communications to and from IP server 16 and patent attorney network 14 may again be handled by communication module 13. IP server 16 operates to log, control, manage and otherwise dispose of ideas submitted for patent through patent attorney network 14. Collectively, issued and pending patents processed through system 10 are denoted hereinafter as “Pending IP”. Communications between filter network 12 and IP server 16, and between patent attorney network 14 and IP server 16 may be secure and/or encrypted.

IP server 16 is illustratively shown with a processor 17, though it may include one or more databases, additional processors, memory, computer systems, software and logic that enables the functions herein described; it may thus be formed of distributed devices over a network. In one embodiment, IP server 16 includes a Pending IP module 18, a prior art management module 20, a transaction module 22, and an attribution module 24. These modules are for example be stored in memory of IP server 16 and constructed via software under control of processor 17. Briefly, Pending IP module 18 operates to control (e.g., display, post) Pending IP on a Website 26 of system 10; it may further remove any Pending IP from Website 26 when either it is purchased or deemed unpatentable. In an embodiment, IP Server 16 contains a web server 21 to generate and maintain web site 26, although an external web server may also be used to generate and maintain web site 26 without departing from the scope hereof. Web server 21 for example generates pages for web site 26 under control of pending IP module 18. Prior art management module 20 operates to store, categorize and associate prior art with pending IP; system 10 may be configured to receive such prior art from computers connected to system 10, such as computers 28 (shown illustratively as computers 28(1) . . . 28(Q), Q being an integer) connected to system 10 via a network (e.g., Internet) 30. Transaction module 22 operates to sell (or license) Pending IP to external entities desiring to purchase the Pending IP; it may for example function to sell any one or more items of Pending IP to a company that pays the pricing associated with such one or more items of Pending IP. In the example of FIG. 1, the company operates a computer 28. Transaction module 22 may transact title with external persons submitting ideas to system 10, as further described below. Attribution module 24 operates to distribute revenues received in connection with transactions of transaction module 20, for example distributing earnings (e.g., through online banking of a bank 32) to the S&G members of filter network 12, patent attorneys/agents of patent attorney network 14, and/or owners (e.g., shareholders) of system 10.

Ideas may be submitted to system 10 via any one of a port 34 (shown illustratively as plurality computers 34(1) . . . 34(N), N being an integer) connected to system 10 through a network 36 (e.g., the Internet). Accordingly, if a person has an idea he or she desires to commercialize, he or she may simply compose an email at a port 34 and submit the idea to system 10. In the event a person wishing to submit an idea to system 10 does not have a home computer (e.g., computer 34(1)), then that user may instead submit his idea by fax or phone message to communication module 13 via a telephone line 40, in accord with an embodiment. Communication module 13 may process the fax or phone message into electronic text for submission (similar to submission by any of computers 34) to the S&B board of filter network 12; this processing may include, as needed, translating that text into a language understandable by an appropriate person of the S&B board.

The S&B board may include scientists (e.g., microbiologists, computer specialists, doctors, electrical engineers, etc.), business persons (e.g., venture capitalists, financial analysis, hedge fund managers, etc.) and patent experts (e.g., judges) who understand the patent system, the marketplace and the value of innovation. For example, a computer scientist, a microbiologist and a venture capitalist may form an S&B board; however a much larger S&B board with tens or hundreds of individuals is contemplated, so that specialists in science and business are appropriately represented to evaluate incoming idea submissions for system 10. Each specialist of the S&B board has a unique address (e.g., email address associated with one of computers 12) so that incoming ideas may be appropriately routed (e.g., automatically by operation and intelligence of IP server 16) to such specialist as appropriate. IP server 16 is illustratively shown with a data store 19 which may for example be used to cross-reference each specialist of the S&B board with a particular computer address of filter network 12. Similarly, data store 19 may be used to cross-reference each attorney/agent of patent attorney network 14. In one embodiment, communication module 13 tracks availability of persons of filter and patent attorney networks 12, 14 for efficient communication, processing and patenting of ideas by system 10. In an embodiment, filter network 12 and patent attorney network 14 interact with communication module 13 using web server 21 and web site 26. S&B board members associated with network 12 and patent attorneys and agents of network 14 may access a secure area of web site 26 that is not available to computers 28 and 34.

IP server 16 may also contain a search engine 23 to facilitate searching of pending IP and to identify related art external to IP server 16. In one example, search engine 23 locates pending IP by users of web site 26, according to entered search criteria. In another example, filter network 12 and/or patent attorney network 14 use search engine 23 to locate prior art that is relevant to submitted ideas.

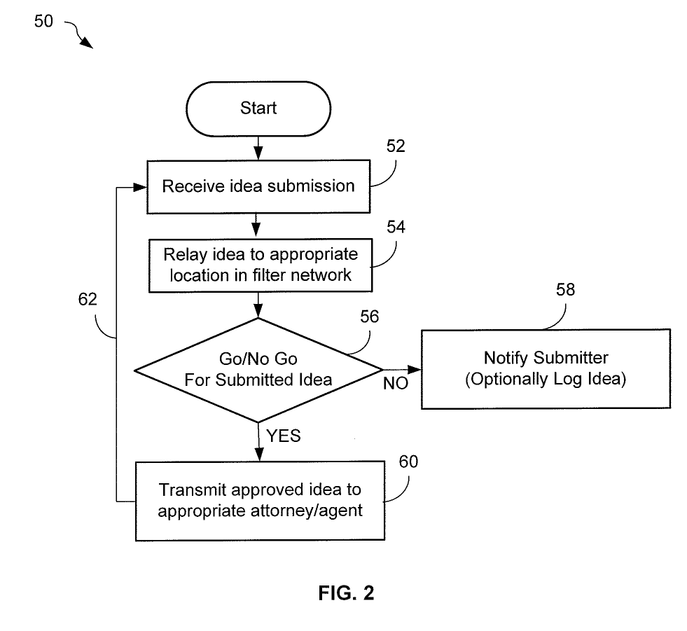

Once an idea is submitted, system 10 may generally initially operate as follows and as illustrated in the attached flowchart of FIG. 2. In particular, FIG. 2 shows an idea submission process 50 that is for example implemented by communication module 13 under control of processor 17.

In step 52, system 10 receives an idea submitted by a person or entity desiring to commercialize that idea. In an example of step 52, a person at computer 34(1) sends an email explaining the idea to system 10, and therefore to module 13, through network 36. In another example of step 52, a person in India submits an idea by facsimile to module 13 via telephone line 40. In another example of step 52, a person at computer 34(1) interacts with one or more pages of web site 26 to submit ideas to communication module 13 of system 10.

In step 54, the submitted idea of step 52 is relayed to the appropriate location (person on the S&B board) of filter network 12. In an example of step 54, communication module 13 processes the email and determines, for example, that the present idea relates to a particular field of biotechnology and that, therefore, a biology specialist associated with computer 12(5) is the appropriate party to review the idea. Module 13 then for example emails the particular idea submission to the person at computer 12(5). In another example of step 54, communication module 13 processes the idea submitted via web site 26 and determines that the present idea relates to a particular field of engineering, and that an engineering specialist associated with computer 12(3) is the appropriate party to review the idea. Module 13 then posts the idea on a secure area of web site 26 and emails the person at computer 12(5) to access web site 26 and review the idea. Module 13 may utilize data store 19 to locate the appropriate person. Data store 19 may include a relational database of email addresses and skills of persons of filter network 12. Relational database may also include utilization information for determining the availability of a person of filter network 12, so that if a person is busy or overloaded the idea is routed to another specialist of filter network 12. In another example of step 54, module 13 processes a German language facsimile, sent via telephone line 40, and determines that the facsimile concerns a new computer processor idea. Module 13 then determines that a certain English-speaking computer specialist is an appropriate and available review party, converts the facsimile to electronic text, converts the text to English and transmits (e.g., emails) the text to the English-speaking computer specialist at an associated computer, e.g., computer 12(6). It should be noted that translating incoming ideas to other languages is also contemplated and that filter and attorney networks 12, 14 may include individuals of many different cultures and languages. Therefore, module 13 may look up the appropriate person in data store 19 (which may also list language or languages of preference for each person) and then communicate a received idea to the appropriate person in the appropriate language and at the appropriate location. Further, in certain circumstances it may be desired to send an idea to multiple persons, for example a science specialist and a business specialist, so that multiple persons review an incoming submitted idea.

In step 56, a go/no-go decision is made. In an example of step 56, a specialist decides whether the idea submitted and relayed in steps 52, 54 is worthy of patenting or further business consideration; if at decision 56 a person or persons of filter network 12 decide No, then step 58 commences; if decision 56 is a go/Yes, then step 60 commences. In step 58, the person submitting the idea is notified that the idea is not of interest. Module 13 for example sends an email or fax to the person with the notification of non-interest.

In step 60, an approved idea is transmitted to an appropriate attorney or agent of patent attorney network 14. In an example of step 60, module 13 assesses which attorney or agent is available and which has expertise to prepare and file a patent application on the present idea; it then transmits the idea, typically in electronic text form, to such attorney or agent at the appropriate address (e.g., at a computer 14). In another example of step 60, module 13 assesses which attorney or agent is available and which has expertise to prepare and file a patent application on the present idea; it then posts the idea to a secure area of web site 26 and notifies such attorney or agent at the appropriate address (e.g., at a computer 14) via email of the availability of the submission.

Process 50 may repeat, as indicated by arrow 62, to process additional submitted ideas from persons (e.g., via a computer 34 and/or facsimile/phone message on telephone line 40 and/or web site 26).

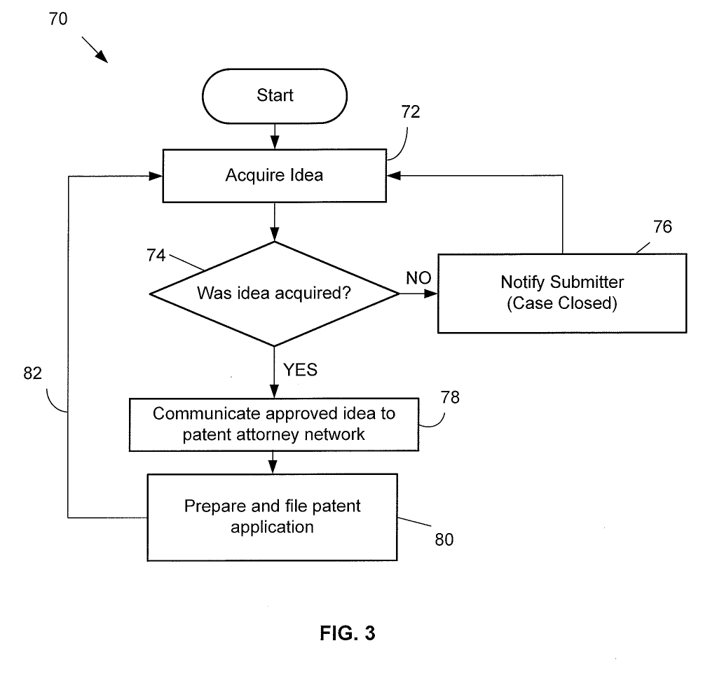

Once an idea is accepted by filter network 12, system 10 may generally initially operate as follows, and as set forth in the attached flowchart of FIG. 3. In particular, FIG. 3 shows an idea acquisition and patent prosecution process 70 that may be implemented by communication module 13 under control of processor 17.

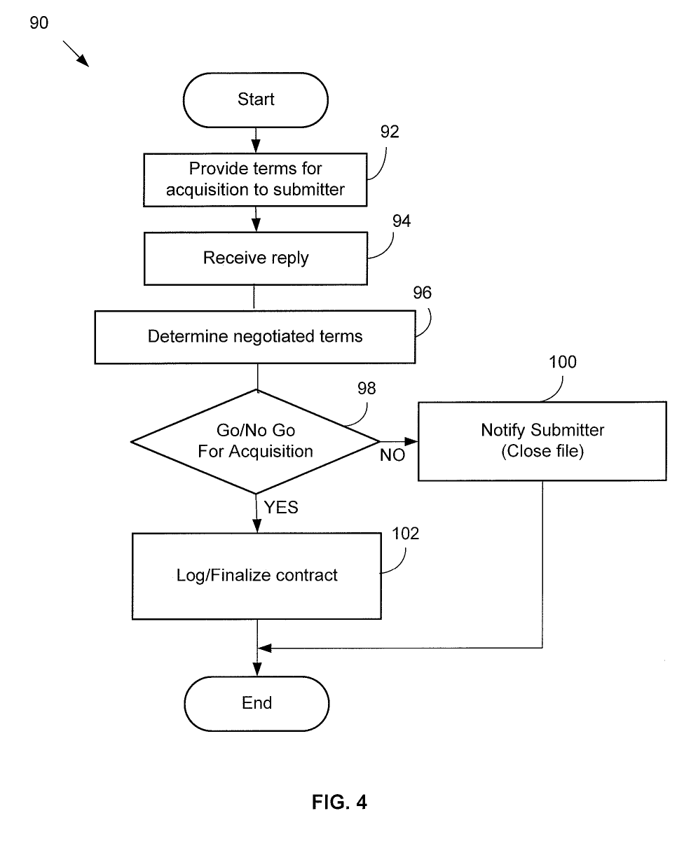

In step 72, an idea approved by filter network 12 is processed for acquisition (so that, for example, title in the idea is transferred to owners of system 10). The idea acquisition process 90 of step 72 is shown in greater detail in FIG. 4. If, decision 74, the idea is not acquired, then process 70 continues with step 76; otherwise it continues with step 78. In step 76, acquisition or other arrangement (e.g., license) of the submitted idea was not obtained; therefore, step 76 notifies the submitter that nothing more will be done. In an example of step 76, communication module 13 notifies the submitter by email at a computer 34 that no further actions will be taken by system 10.

In step 78, the approved/acquired idea is relayed to the appropriate location (person) of patent attorney network 14. In an example of step 78, communication module 13 processes the submitted/approved idea and determines that the present idea relates to a particular field of physics and that, therefore, a physicist patent attorney or agent associated with computer 14(7) is the appropriate party to prepare and file a patent on the idea. Module 13 then emails the particular idea submission to the person at computer 14(7). Module 13 may utilize data store 19 to locate the appropriate person. Data store 19 may include a relational database of email addresses and persons of patent attorney network 14. The relational database may further include utilization information wherein the availability of a person of patent attorney network 14 is determined, so that if a person is busy or overloaded, the idea is routed to another appropriate patent attorney or agent of patent attorney network 14. Module 13 may further process the idea into an appropriate language for the attorney/agent working on the patent, for example converting a facsimile to electronic text, convert the electronic text to German and transmit (e.g., email) the text to a German-speaking patent agent at a computer 14.

In step 80, the assigned patent agent/attorney of network 14 prepares and files a patent application on the submitted/acquired idea. System 10 may automatically file the draft patent application with the U.S. Patent Office or other patent offices worldwide (e.g., via communication module 13). For example; it may electronically file or email the application to the U.S. Patent Office via network 36 or 30, or telephone line 40. Or, the assigned patent agent/attorney may file the patent application by mail (e.g., Express Mail) and then transmit the as-filed patent application to IP server 16 via communication module 13, which then communicates with Pending IP module 18 to post the as-filed patent application as Pending IP.

Process 70 may repeat, as indicated by arrow 82, to process additional patents that are submitted and acquired from persons.

Process 90, FIG. 4, is a title acquisition process that may be implemented by system 10 and more particularly by transaction module 22 under control of processor 17.

In step 92, terms are provided to the person submitting an idea. In an example of step 92, transaction module 22 emails (e.g., through communication module 13) the person submitting the idea (e.g., at a computer 34) with terms to acquire the idea. Typically, those terms provide an agreement that the idea will be filed as a patent application and that revenues received in connection thereof, in licensing and/or litigation, will be shared with the submitter at a certain percentage (e.g., 10-50%). For certain ideas, system 10 may decide that the shared percentage may be less or more, or that the submitting person must pay some amount in order to offset costs of filing the application. For example, the submitting person may be required to pay the current $100 fee for filing a U.S. provisional patent application on the idea. In an embodiment, the terms provided in step 92 are set by the approving person of filter network 12. A category of appropriate license terms are provided to that person and he/she selects the terms under which system 10 continues transacting the idea. System 10 may therefore provide a simple selection process (e.g., using one or more pages of web site 26) by which the approving S&B person of filter network 12 selects terms associated with an idea he or she intends to approve for continued processing (see step 56, FIG. 2).

In step 94, a reply is received from the person submitting the idea. In an example of step 94, the person submitting the idea reviews terms transmitted to her from transaction module 22 and emails a “yes” or “no” or “desire to negotiate” reply to those terms. If allowance is made for additional negotiations (e.g., by the network 12 person selecting the terms), then additional negotiations may commence in step 96. Step 96 may be fairly objective; that is system 10 may automatically adjust percentage of downstream revenue for the submitting person and communicate final terms thereof. Step 96 may also involve a telephone conversation (e.g., with the S&B boardperson who approved the idea for acquisition) if the idea has merit.

The outcome from steps 92, 94, 96 is a go/no go decision 98. If terms are not agreed to (no go), process 90 continues with step 100; otherwise process 90 continues with step 102. In step 100, notification that terms cannot be reached is communicated to the submitting person, and files may be closed. In step 102, a contract is finalized, signed and logged into a database of system 10; processing continues with step 74, FIG. 3.

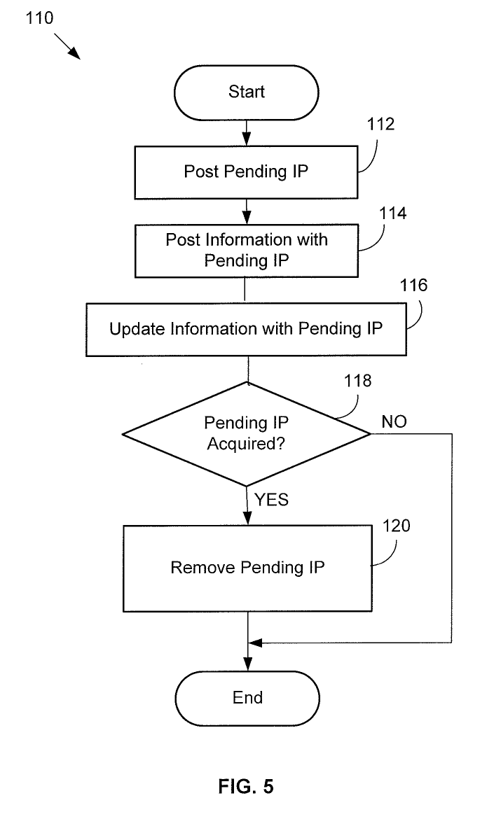

FIG. 5 shows a flowchart illustrating a post Pending IP process 110 for commercializing intellectual property. Process 110 may for example be implemented by Pending IP module 18 under control of processor 17. In step 112, patents filed by attorney network 14 are posted. In an example of step 112, Pending IP module 18 utilizes web server 21 to post a PDF of a patent application on website 26. In step 114 (which may be combined with step 112 if desired), information associated with Pending IP is also posted, for example in association with Pending IP, on Website 26. Examples of such information include terms for purchasing or licensing the Pending IP.

Optionally, information associated with Pending IP is updated, as in step 116. Such updating may be performed by Pending IP module 18 when any Pending IP issues as a patent —which normally increases pricing for acquisition of such Pending IP. Or, if Pending IP is associated with successful litigation, then pricing for such Pending IP is also appropriately increased. Pending IP may be automatically updated with information in step 116 upon the occurrence of events such as allowance, issuance or other prosecution events, results of litigation, lapse of time between events or since filing, and the like. Terms for updated information are for example stored in data store 19 of IP server 16 and updated from time to time.

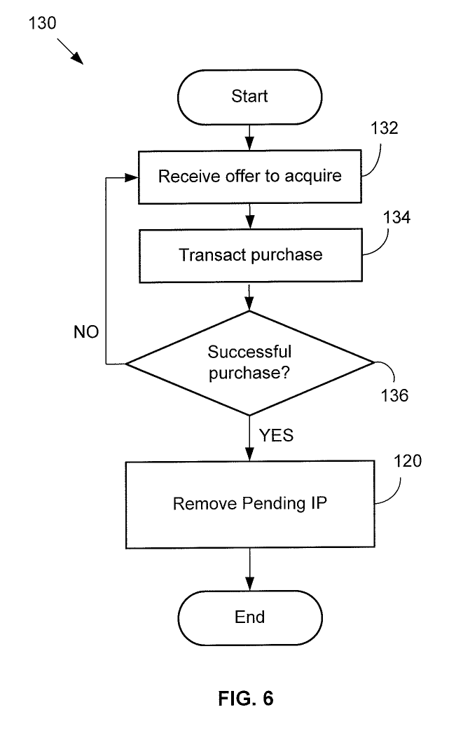

In the event certain Pending IP is purchased (step 118; see also FIG. 6), then, at step 120, Pending IP module 18 may remove sold Pending IP from posting, so it is no longer shown as available for sale on website 26. Pending IP module 18 for example learns of a successful transaction of Pending IP and removes the sold Pending IP from transaction module 22.

FIG. 6 shows a flowchart illustrating a sell Pending IP process 130 for commercializing intellectual property. Process 130 may for example be implemented by transaction module 22 under control of processor 17.

In step 132, system 10 receives an offer to acquire certain Pending IP. In an example of step 132, transaction module 22 receives an email from an inquirer, transmitted to system 10 via a computer 28 and network 30. A user at a company (e.g., using a computer 28) may view Pending IP (e.g., resulting from a search for certain types of IP using search engine 23) at website 26 and desire to purchase same; that user may also view the sale price and simply email system 10 (through network 30) that his company will purchase that Pending IP. In another example, the user interacts with web server 21 using web site 26 to indicate interest in viewed Pending IP. In step 134, purchase (or license) of the subject Pending IP is transacted, such as set forth by terms associated with the posted Pending IP. For example, the Pending IP is acquired through a credit card, wire transfer or on-line cash payment.

The purchase price (terms) for new (recently filed) Pending IP may increase automatically, over time, such as when the Pending IP issues as described herein. Initially, for example, such Pending IP may have a price of $50,000-$100,000; but as the Pending IP advances through prosecution and/or ages, the price and terms may increase. In one example, the price doubles when the Pending IP actually issues into a patent. It may also increase dramatically—e.g., to several or many millions of dollars—if the Pending IP is litigated successfully in court.

Step 136 is a decision. If the transaction/purchase is successful, step 120 commences (see FIG. 5); otherwise step 132 commences (i.e., other offers may be resubmitted and transacted).

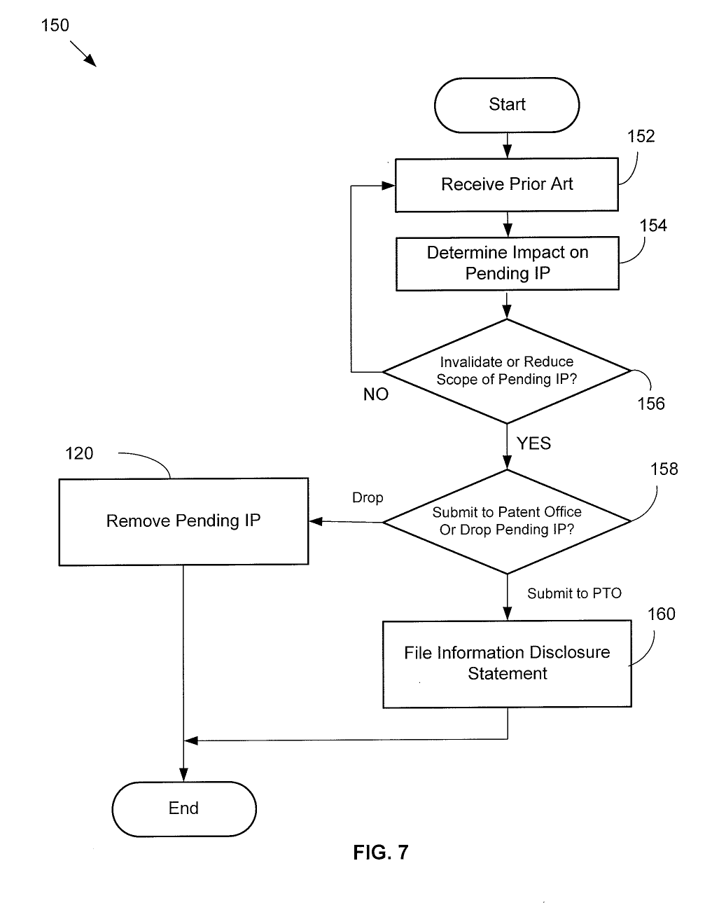

FIG. 7 shows a flowchart illustrating a prior art association process 150 for commercializing intellectual property. Process 150 may for example be implemented by prior art management module 20 under control of processor 17. In step 152, system 10 receives prior art from external sources. In an example of step 152, a user at a company (using a computer 28 and viewing Pending IP at Website 26) decides that such Pending IP is already in the public domain or anticipated by prior art; that user may submit such prior art to system 10 and prior art management module 20 thereby associates such prior art with the Pending IP. In so doing, prior art management module 20 determines impact, if any, on the Pending IP because of the submitted prior art, in step 154. The attorney/agent of network 14 who wrote the subject Pending IP may be utilized in step 154, such as by routing the prior art to this most knowledgeable attorney/agent. If there is no impact, system 10 continues to accept other prior art in step 152; but if, decision 156, the submitted prior art is material to patentability of the Pending IP, then a decision is made in step 158 as to whether the prior art invalidates the subject Pending IP. Decision 158 is for example made by system 10 using electronic document processing and analysis, and/or in conjunction with attorneys/agents of network 14. If the prior art invalidates the subject Pending IP, then step 120 commences. If the submitted prior art only narrows the scope of the Pending IP, or if the prior art is material to patentability of the Pending IP, then step 160 commences. In step 160, an information disclosure statement may be automatically prepared for submission to the patent office; that information disclosure statement may further be automatically submitted by prior art management module 18.

More particularly, if a person or company seeks to devalue or diminish the likelihood of an actual patent issuing on Pending IP by communicating prior art (e.g., patents or articles relating to the pending IP) to system 10, he may do so; in fact, system 10 encourages this so that only good patents actually issue thereon. If prior art is significant to patentability of the Pending IP, then the owners/attorneys of system 10 have an obligation to report the prior art to the patent office. Accordingly, system 10 facilitates identification and posting of such prior art—which may make it impossible to obtain a patent on the pending IP, saving everyone (inventor, assignee and other companies) time and money, since it is very expensive to invalidate an issued patent through litigation or reexamination.

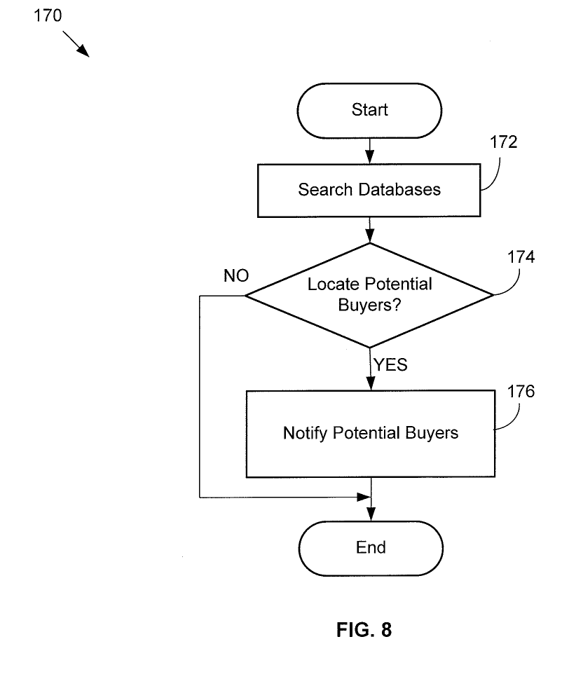

FIG. 8 shows a notify potential buyer process 170 for commercializing intellectual property. Process 170 may for example be implemented by Pending IP module 18 under control of processor 17. In step 172, databases are searched to locate likely buyers of Pending IP posted on Website 26. In an example of step 172, Pending IP module 18 utilizes search engine 23 to search patent databases to find inventors and/or companies that file patents in similar fields. Step 174 is a decision. If such inventors/companies (referred to in FIG. 8 as “potential buyers”) are found, then step 176 commences; otherwise step 172 commences. In step 176, the potential buyers are notified. In an example of step 176, Pending IP module 16 mails, emails and/or faxes such inventors/companies information about the Pending IP, thereby providing “notice” (e.g., perhaps sufficient for 37 C.F.R. §1.56) of prior art in the form of the Pending IP. Such inventors/companies may then be forced to identify the Pending IP in pending patent applications owned or processed by such inventors/companies due to Rule 56.

For example, system 10 may utilize search engine 23 to automatically search databases, such as databases available on the Internet, to locate and identify inventors and companies that have, or are developing, technology similar to the Pending IP. This searching may include searching of patent databases, such as public databases within the U.S. Patent Office. For searching purposes, system 10 may associate and store with each Pending IP one or more descriptive terms that sufficiently define the Pending IP. For example, if the Pending IP is an idea for a car tire, the descriptive terms might include “automotive” and “tire.” In another example, if the Pending IP covers an idea for a topical sunscreen that goes on colored and then goes clear upon application, then the descriptive terms might include “disappearing colored sunscreen.”

Such notification may have beneficial results. For example, in the U.S., notified inventors and/or companies having pending patent applications relating to the similar technology, may be legally obligated to inform the patent office of the notice, typically in the form of an information disclosure statement. This obligation encourages the inventors and/or companies to purchase the Pending IP related to their similar technology or else risk losing their own pending applications. Specifically, if a person or company becomes aware of Pending IP—by receiving the notice or by reviewing posted Pending IP in the database—and if that Pending IP is material to their own pending patents, then that person or company must disclose the pending IP in any of their pending patent applications. Such an obligation encourages negotiations (see process 130, FIG. 6) for the Pending IP.

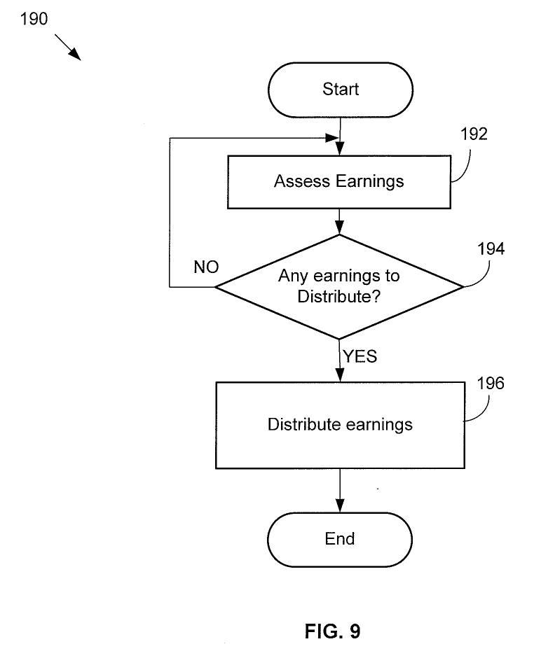

FIG. 9 shows a distribute earnings process 190 for commercializing intellectual property. Process 190 is for example implemented by attribution module 24 under control of processor 17. In step 192, an assessment of earnings is made. In an example of step 192, IP Server 16 determines how much money is associated with a particular Pending IP. Step 194 is a decision. If there are earnings to distribute, step 196 commences; otherwise step 192 commences (i.e., continues to monitor earnings).

Earnings to people associated with system 10 may be provided in step 196. Earnings are for example distributed based upon formula or tables stored within IP Server 16. In one example of step 106, the original inventor of an idea submission is owed 50% of his idea due to an initial transaction (see process 70, FIG. 3), according to terms associated therewith. Accordingly, if system 10 receives $100,000 for a certain Pending IP, and 50% is owed to the inventor, then in step 196, $50,000 is transferred to such inventor (e.g., through online banking of bank 32). Typically, the attorney/agent of patent attorney network 14 also earns an interest in Pending IP that earns income. Attribution module 24 may also distribute such earnings to the attorney/agent according to the terms for which that attorney/agent drafted the Pending IP (for example in the range 10-20%). Others too may receive distribution for earnings. For example, if any Pending IP is part of litigation which results in settlement, then a contingent percentage (e.g., 40%) may be dispersed to the contingent lawyers, prior to distribution of other monies to inventors and attorney/agents of the associated Pending IP (that is, the 40% may be paid prior to splits to any other person, including the original person submitting the idea). Finally, attribution module 24 may disperse other monies remaining to persons of the S&B board and to shareholders or members that own system 10.

In one embodiment, persons of the S&B board are compensated for each idea assessed, for example $100 for each idea processed by the person. Therefore attribution module 24 may immediately pay the person each time a go/no-go decision is made; additional attribution based on earnings (process 190 of FIG. 9) may additionally be paid, or not, to the S&B board person. In another embodiment, attribution module 24 tracks the time each person spends on a particular Pending IP, including the amount of time it takes to process the idea at the S&B board (network 12), to process the patent at network 14, and/or other individuals associated with IP Server 16, so that payment of earnings or other monies associated with system 10 are paid based on the actual amount worked. Networks 12, 14 may for example automatically log the amount of time any given person spends on a particular Pending IP, so that appropriate adjustments may be made to compensate such individuals.

Accordingly, system 10 may encourage the selling of patent applications and ideas without the necessity of obtaining an actual patent. Another feature may be that commercialization of innovation does not require an issued patent, so that commercialization may occur more rapidly with patent applications.

In an embodiment, Pending IP posted on Website 26 may not be the entire patent application but instead just the main embodiment and a brief description, so that users of the Internet may review, and know of, the Pending IP. Alternatively, system 10 may post the entire patent application of the Pending IP, or a subset thereof. In one example, users of web site 26 may subscribe to receive new IP notification messages distributed (e.g., via a daily/weekly/monthly email) by Pending IP module 18 and/or communication module 13 for new Pending IP in specified fields.

To encourage the sale of Pending IP, system 10 (e.g., prior art management module 20 under control of processor 17) may automatically search prior art databases for prior art similar to descriptive terms associated with Pending IP, and then automatically prepare and report an information disclosure statement based on prior art located during that search. In this way, system 10 may seek to validate the value of a Pending IP early and before actual issuance, to increase the likelihood of issuance of the Pending IP and make it more likely that someone desiring to buy the Pending IP may do so with confidence it will actually issue. Moreover, the value of the Pending IP in this embodiment is strengthened, since a more thorough prior art search is conducted. Prior art submitted by third-party companies, and relative to certain Pending IP, may also be automatically submitted as an information disclosure statement to the patent office. See process 150, FIG. 7.

Similarly, therefore, system 10 may perform services for third-parties desiring to post Pending IP, and/or desiring to strengthen Pending IP. By way of example, for a service fee, system 10 may perform services for third parties, including posting their IP, searching for prior art, and/or seeking other prior art (through searching and/or through prior art submitted to the system from still other third parties) for posting with the IP. System 10 may be particularly useful in obtaining knowledge of conception of thousands of ideas—which too may be sold in the marketplace, for example within patent litigation that seeks to invalidate actual patents.

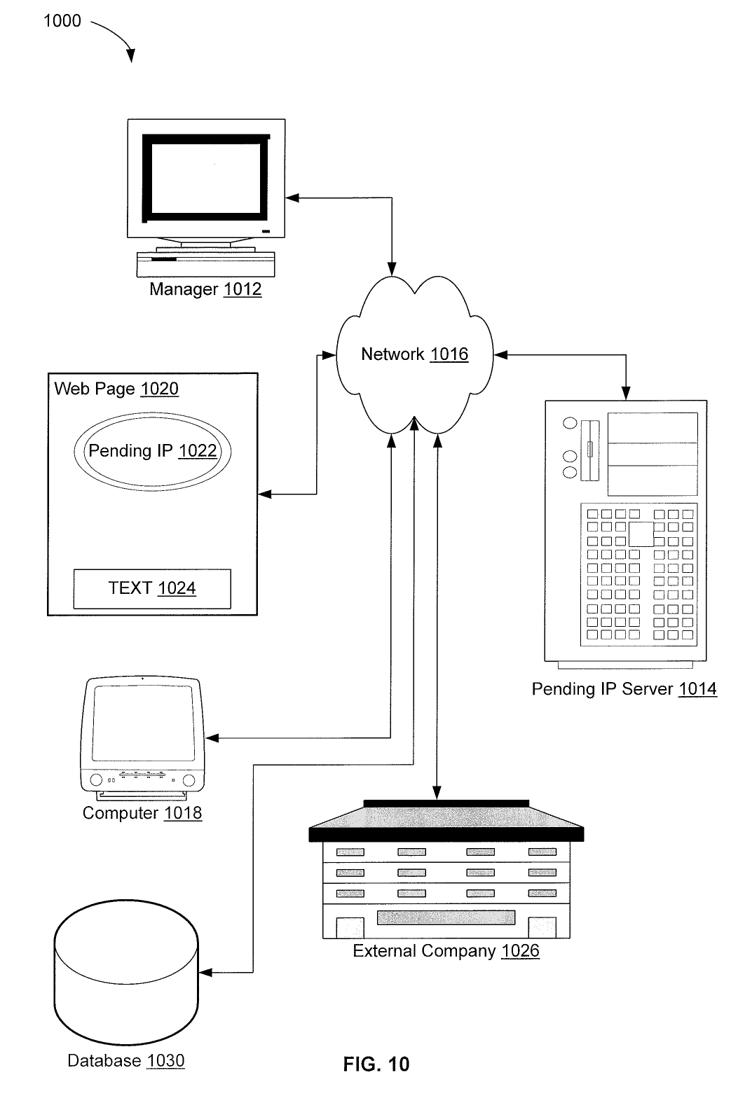

FIG. 10 schematically shows another system 1000 to strengthen and commercialize Pending IP. It is within the scope of this disclosure that features of system 1000 may also reside with system 10, FIG. 1, and vice versa. System 1000 includes a manager 1012 and a Pending IP server 1014 connected together by a network 1016 (e.g., the Internet). Manager 1012 may connect directly with server 1014 without departing from the scope hereof. One or more ideas are packaged and stored within server 1014 as Pending IP. In operation, manager 1012 posts the Pending IP with server 1014 so that persons (e.g., a person at computer 1018) connected to network 1016 may view selected Pending IP; by way of example, exemplary Pending IP 1022 may be displayed within a web page 1020 generated by web server 21. Each page 1020 may also describe Pending IP 1022, such as through text within a text box 1024. Other computers such as computer 1018 may reside within a company such as company 1026 so that others may review Pending IP (e.g., Pending IP 1022) of server 1014.

Manager 1012 and/or server 1014 may send notices to computer 1018 (or alternatively to computers of company 1026) informing users of such computers of Pending IP. In this way, system 1000 puts these users ‘on notice’ so that they may become interested in buying the Pending IP. Further, if company 1026 has materially similar patents pending within the U.S. patent office, this notice obligates company 1026 to inform the U.S. patent office of the Pending IP. This notice may also automatically occur, without manager 1012 and/or server 1014 sending notice, if the users or company 1026 visits web site 1020 and sees materially relevant Pending IP 1022. Notices sent to company 1026 may take the form of regular mail; however email may be used. Faxes may also be sent, e.g., automatically, as notification.

System 1000 may connect with a database 1030 via network 1016; database 1030 may include patent and prior art information searchable by manager 1012 and/or server 1014. System 1000 searches database 1030 (e.g., using search engine 23) for prior art relating to one or more of the Pending IP within server 1014; if prior art is located, system 1000 may automatically prepare and dispatch an information disclosure statement to the U.S. patent office, notifying the patent office of the prior art. In this way system 1000 strengthens any subsequent issuance of Pending IP as more prior art will be cited with the associated patent. Searching for prior art may utilize text within text box 1024 as “descriptive text” for the Pending IP, utilizing the descriptive text to search database(s) 1030. Database 1030 may also comprise a database such as a public database searchable through the Internet. Database 1030 may include two or more databases at different locations, and/or may include a dedicated database unique to system 1000 (e.g., database 1030 may be part of, or directly associated with, Pending IP server 1014, for example).

Prior art may also be submitted to manager 1012 and/or server 1014 by computer 1018 and/or company 1026. For example, computer 1018 may submit an electronic version (e.g., a PDF file) of a patent or article to manager 1012 and/or server 1014 that substantially anticipates Pending IP 1022; this constitutes notice to system 1000 and an information disclosure statement may be prepared and submitted for this prior art. In this way, system 1000 reduces the likelihood of issuing patents if material prior art already exists. World-wide users of system 1000 may thus provide prior art to affect the issuance of Pending IP 1022 in either positive or negative ways: in positive ways, by enhancing the value of a subsequently issued patent, by increasing cited prior art in a resulting patent; or in negative ways, by helping to invalidate, diminish or stall the issuance of the Pending IP.

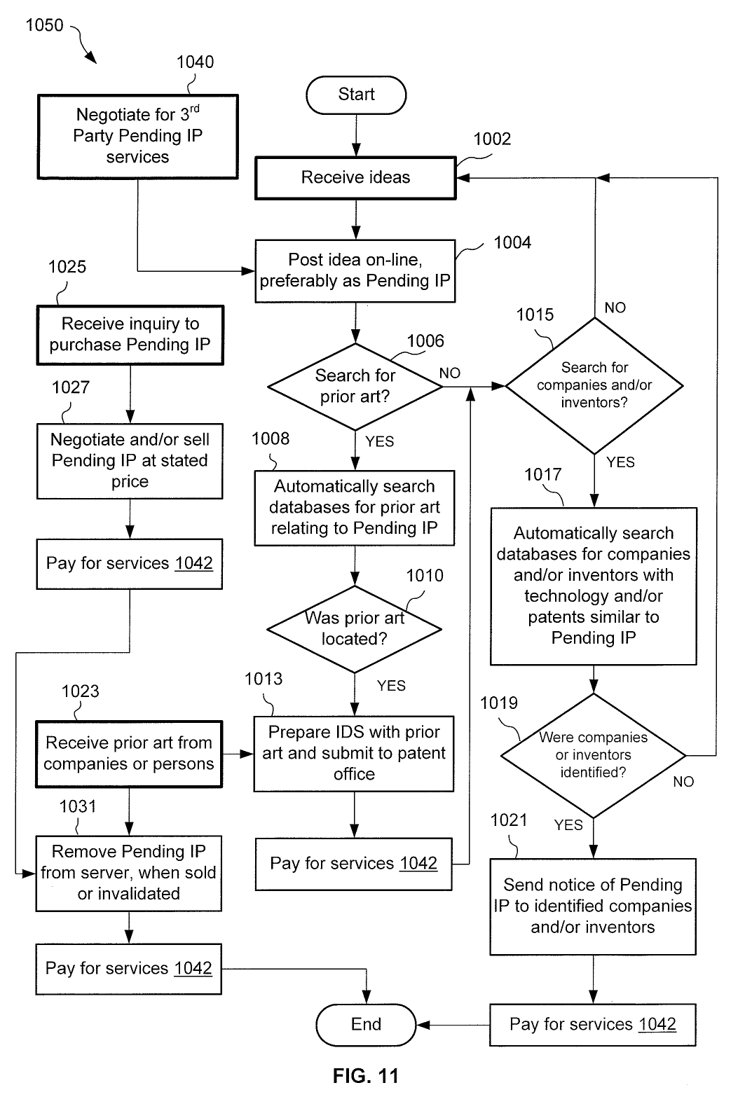

FIG. 11 illustrates a flowchart of one process 1050 suitable for processing, strengthening and commercializing Pending IP of system 1000, FIG. 10. At step 1002, system 1000 receives ideas from inventors desiring to use system 1000. If elected, an idea is posted on-line as a picture and/or associated text (step 1004); the idea may also be filed as a pending patent application, making the posted idea “Pending IP.” Optionally (decision 1006), system 1000 may search for prior art, such as within database 1030. If a search is conducted, system 1000 searches one or more databases (e.g., a patent office database 1030) to find prior art (step 1008). If prior art is located (decision 1010), that prior art is bundled as an information disclosure statement and sent to the patent office (step 1013).

Optionally, system 1000 may search for inventors and/or companies engaged in technology relating to Pending IP (decision 1015), such as through the Internet or other databases 1030. If this search is conducted, system 1000 searches one or more databases to identify such inventors and/or companies, if existing (step 1017). If such companies and/or inventors are identified (decision 1019), a notice is generated (step 1021) to inform the companies and/or inventors of the Pending IP; the notice of step 1021 may be an email notice, fax or mail generated automatically by system 1000.

System 1000 may also receive (step 1023) prior art from outside sources, such as from the companies and/or inventors of company 1026, FIG. 10. If received, system 1000 bundles that prior art as an information disclosure statement and sends it (step 1013) to the patent office. If however the prior art anticipates the Pending IP, system 1000 may remove the Pending IP from the server (step 1031).

System 1000 may also receive (step 1025) inquiries to purchase Pending IP, such as when a company learns that the Pending IP exists after receiving notice, or when a company 1026 views web page 1020, FIG. 10. System 1000 may preset a price for the Pending IP and state the price in the text box (see, e.g., text 1024, FIG. 10) posted on-line, or system 1000 may negotiate for the Pending IP (using upper and lower limits of value for an acceptable sale) in step 1027. If sold, system 1000 may remove the Pending IP from the server (step 1031).

In one embodiment, system 1000 may offer services, for a fee, that embody processes outlined in process 1050. For example, in step 1040, system 1000 (e.g., through server 1014) may negotiate (for a fixed fee, or through on-line negotiations) with a third party to post Pending IP (step 1004), search for and report prior art (steps 1008 and 1013), search for and notify other companies with similar technologies (steps 1015-1021) and/or sell Pending IP (steps 1025-1031). System 1000 may receive a fee for such services (illustratively shown as payment step 1042) such as through a bank transaction (e.g., through bank 32, FIG. 1); such transactions may occur at one or more locations, such as shown in FIG. 11 by steps 1042.

Systems and methods disclosed herein may have certain advantages. The phrase “ideas are a dime a dozen” is used by entrepreneurs to denote that an idea is less important than the execution of the idea. However, systems and processes disclosed herein may operate to obtain ideas inexpensively and then filter weak ideas from strong ones, so that the strong ideas are more quickly brought to market. Second, it is fairly common that an individual sees a product on the market only to lament, to himself, “I thought of that idea!” So, systems and processes disclosed herein may provide such persons with the opportunity to capture some benefit associated with their idea as opposed to doing nothing (and/or spending thousands of dollars on a patent lawyer to file a patent on the idea) and then watching the marketplace develop (years later) without them. Accordingly, innovation readily increases since the marketplace has early awareness of its existence.

It is also known that prior art can make or break any patent litigation—and that therefore it would be much better for all, at least in cost, if that prior art were considered prior to patent issuance. It has been argued that only a fraction of patents now issuing deserve to issue. Systems and processes herein may thus assist in managing and associating prior art with pending patents, thereby strengthening patents and reducing litigation.

Systems and processes herein may also assist innovation because, generally, ideas are published early—perhaps within a week or so of an idea being submitted to system 10, 1000. Publication under current world rules under the WTO is eighteen months, or later in the USA; systems and processes herein may shorten the publication to a much shorter period, wherein Pending IP is posted in a website (see web page 1020, FIG. 10). This early publication, under the patent statutes, can be a sword and a shield; it either limits downstream patenting or makes downstream patents more specific.

Start-up companies may also benefit from systems and processes herein. They often strive for acquisition or to be public (a rare occurrence), so the reality is if they have any value at all they are eventually acquired—a process that may actually slow or add cost to innovation. But by utilizing systems and methods herein, innovation may instead be quickly distributed to the company/individual most likely to successfully commercialize the innovation, rather then delaying disclosure of innovation through small, inefficient start-ups. Moreover, an inventor of a patent can sometimes make about the same amount licensing the patent as in the case where the patent is used in a start-up and he/she is often extremely lucky to be acquired after several rounds of dilutive venture capital investment. Experienced entrepreneurs know the trade-offs of a small company are not always good. Using the systems and methods herein, a person may potentially obtain some advantage (downstream revenue) in an idea without patenting it himself and/or starting a company, each of which, again, may slow innovation.

Patent litigation provides automatic and valuable brand recognition (because it is widely publicized for free). Patent plaintiffs are favored in the outcome. And, patent litigation expenses (outside of rare injunctions) sometimes exceed the true value of the underlying intellectual property. Systems and processes herein may actually slow litigation and encourage honest, cost-effective licensing techniques.

The “not invented here” syndrome is often not generally beneficial to any company. Systems and processes herein may provide an objective platform to trade, obtain and sell intellectual property in a manner most efficient to that organization, and without concern for association of the actual inventor.

Patent costs in the marketplace are often too expensive for many companies—attorneys' fees are rising and rising. Systems and processes herein may provide a fair and cost-effective forum to obtain and dispose of ideas and without sinking huge costs into obtaining the intellectual property.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A software product comprising instructions, stored on computer-readable media, wherein the instructions, when executed by a computer, perform steps for commercializing intellectual property, comprising:
instructions for receiving an idea submission from an originator;
instructions for communicating the idea submission to an appropriate person of a filter network;
instructions for submitting the idea submission to an appropriate attorney/agent of a patent attorney network if the idea submission is accepted by the filter network; and
instructions for posting intellectual property representative of the idea submission as Pending IP.

2. The software product of claim 1, further comprising instructions for notifying the originator if the idea submission is not accepted by the filter network.

3. The software product of claim 2, the instructions for notifying comprising instructions for sending an email to the originator.

4. The software product of claim 1, further comprising instructions for acquiring the idea associated with the idea submission if the idea submission is accepted.

5. The software product of claim 1, further comprising instructions for providing terms to the originator of the idea submission.

6. The software product of claim 5, further comprising instructions for receiving a reply from the originator as to the terms.

7. The software product of claim 5, further comprising instructions for providing a contract to acquire the idea submission to the originator.

8. The software product of claim 7, further comprising instructions for logging the contract in a database as evidence of title transfer.

9. The software product of claim 1, further comprising instructions for posting information in association with any Pending IP.

10. The software product of claim 9, further comprising instructions for updating the information when the Pending IP has a status change.

11. The software product of claim 10, the status change comprising one or more of issuance of the Pending IP, successful litigation of the Pending IP and age since filing the Pending IP with a patent office.

12. The software product of claim 1, further comprising instructions for removing particular Pending IP posted on a website if the particular Pending IP is acquired or deemed invalid.

13. The software product of claim 1, further comprising instructions for transacting sale of any Pending IP.

14. The software product of claim 1, further comprising instructions for receiving prior art over a network and for associating prior art with Pending IP.

15. The software product of claim 14, further comprising instructions for assessing impact on Pending IP based on the prior art.

16. The software product of claim 15, further comprising instructions for preparing an information disclosure statement with the prior art.

17. The software product of claim 16, further comprising instructions for submitting the information disclosure statement to a patent office.

18. The software product of claim 1, further comprising instructions for locating potential buyers of Pending IP based upon information on the Internet or within one or more databases.

19. The software product of claim 18, further comprising instructions for notifying the buyers.

20. The software product of claim 19, the instructions for notifying comprising instructions for emailing the buyers.

21. The software product of claim 1, further comprising instructions for distributing earnings associated with sale of any Pending IP according to terms associated therewith.

22. A system for commercializing intellectual property, comprising:
an IP server;
a filter network for filtering ideas to the IP server; and
a patent attorney network for filing patents on ideas accepted by the filter network;
the IP server posting filed patents, or portions thereof, as Pending IP, and being capable of transacting Pending IP through electronic communication.

23. The system of claim 22, the filter network comprising a plurality of individuals of a science and business board, each of the individuals having a unique computer address.

24. The system of claim 22, the patent attorney network comprising a plurality of individuals, each of the individuals having a unique computer address.

25. The system of claim 22, the IP server having a communication module for communicating submitted ideas from external computers and telecommunications to one or both of the filter and patent attorney network.

26. The system of claim 22, the IP server having a Pending IP module for posting Pending IP on a website and for removing posted Pending IP when either purchased, licensed or deemed invalid.

27. The system of claim 22, the IP server having a prior art management module for receiving prior art from external computers and for determining impact of such received prior art on Pending IP.

28. The system of claim 22, the IP server having a pending IP module for locating potential buyers of Pending IP and notifying such buyers thereof.

29. The system of claim 22, the IP server having a transaction module for disposing of Pending IP posted on a website linked with the IP server.

30. The system of claim 22, the IP server having an attribution module for attributing earnings to individuals associated with the filter and patent attorney network.

31. A system for commercializing intellectual property, comprising:
means for processing one or more ideas submitted to the system;
means for acquiring title to the ideas;
means for facilitating patenting of the ideas;
means for posting pending IP representative of the ideas;
means for transacting sale or license of the pending IP;
means for automatically attributing and allocating revenues to persons associated with processing, patenting and protecting the pending IP;
means for processing submitted prior art in association with pending IP; and
means for searching prior art databases to associate prior art with pending IP.
